(19) United States
(12) Patent Application Publication
(10) Pub. No.: US 2010/0037853 A1
(43) Pub. Date: Feb. 18, 2010

(54) INTAKE SYSTEM FOR AN INTERNAL COMBUSTION ENGINE

(75) Inventors: Tomihisa Tsuchiya, Aichi-ken (JP); Masao Ino, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignees: TOYOTA JIDOSHA KABUSHIKI KAISHA, Toyota-shi, Aichi-ken (JP); DENSO CORPORATION, Kariya-City, Aichi-Pref (JP)

(21) Appl. No.: 12/530,069

(22) PCT Filed: Mar. 6, 2008
(86) PCT No.: PCT/IB08/00870

§ 371 Date: Sep. 11, 2009

(30) Foreign Application Priority Data
Mar. 6, 2007 (JP) 2007-056039

(51) Int. Cl. F02B 31/00; F02M 35/10

(52) U.S. Cl. 123/306; 123/184.56

(57) ABSTRACT

An intake system for an internal combustion engine includes: an intake passage (50) through which the intake air is introduced into a combustion chamber (40); an intake manifold (100) that is attached to a cylinder head (30) and forms a part of the intake passage (50); an intake air control valve (200) that reduces the flow passage area of at least a part of the intake passage (50); a valve shaft (300) that supports one end portion (210) of the intake air control valve (200) in a manner such that the intake air control valve (200) is allowed to pivot about the valve shaft (300); and a guide rib (400) that protrudes from the intake manifold (100) toward the one end portion (210), and that minimizes the gap between the one end portion (210) and a portion of the wall surface of the intake passage (50), which is close to the valve shaft (300).

### BACKGROUND OF THE INVENTION

1. Field of the Invention

The invention relates generally to an intake system for an internal combustion engine, and, more specifically, to an intake system for an internal combustion engine, which includes an intake air control valve.

2. Description of the Related Art

There is an intake system for an internal combustion engine, which controls an intake air flow by executing an opening/closing control over an intake air control valve provided in an intake passage, thereby producing vortex flows such as a tumble flow (longitudinal vortex) and a swirl flow (lateral vortex) in a combustion chamber. These vortex flows enhance the combustion efficiency and promote stratified charge combustion in the internal combustion engine.

For example, Japanese Unexamined Utility Model Application Publication No. 7-25264 (JP-UM-A-7-25264) describes an intake system for an engine, in which a passage of an intake port is partitioned into a first passage and a second passage by a partition wall and an intake air control valve that fully closes or fully opens the second passage is provided.

Japanese Patent Application Publication No. 2003-206761 (JP-A-2003-206761) describes a variable flow-rate intake air feeding system including intake air control valves provided to respective four cylinders of an in-line four-cylinder internal combustion engine.

In the systems as exemplified above, an air flow (which is referred to as a “main flow” in this specification) that produces a vortex flow may be affected by an air flow that passes through a gap between a portion of a cantilever intake air control valve that is supported by a valve shaft (this portion of the intake air control valve will be referred to as “one end portion” in this specification) and a portion of a wall surface of the intake passage, which is close to the valve shaft. This hinders enhancement of the combustion efficiency and promotion of the stratified charge combustion in the internal combustion engine.

### SUMMARY OF THE INVENTION

The invention provides an intake system for an internal combustion engine which allows the intake air to flow in a more appropriate fashion.

A first aspect of the invention relates to an intake system for an internal combustion engine, which introduces intake air into a combustion chamber of the internal combustion engine. The intake system includes: an intake passage through which the intake air flows; an intake manifold that is attached to the internal combustion engine and that forms a part of the intake passage; an intake air control valve that is able to reduce the flow passage area of at least a part of the intake passage; a valve shaft that supports a one end portion of the intake air control valve in a manner such that the intake air control valve is allowed to pivot about the valve shaft; and a gap minimizing portion that protrudes from a component other than the intake air control valve toward the one end portion of the intake air control valve, and that minimizes the gap between the one end portion and a portion of a wall surface of the intake passage, which is close to the valve shaft.

With the configuration as described above, the gap between the one end portion of the intake air control valve and the wall surface of the intake passage is minimized by the gap minimizing portion. Therefore, the air flow that passes through the gap is suppressed, the intake air flows in a more appropriate fashion. As a result, the combustion characteristics are improved.

The component other than the intake air control valve may be a component included in the intake manifold, or may be an insertion member that is inserted and fitted into the intake manifold and that forms a part of the intake passage.

In the intake system according to the aspect of the invention described above, the gap minimizing portion may extend along the direction in which the intake passage extends, and may form a part of the intake passage.

With the configuration as described above, the influence of the presence of the gap minimizing portion on the flow of the intake air is minimized because the gap minimizing portion extends along the direction in which the intake passage extends. As a result, it is possible to allow the intake air to flow in a more appropriate fashion, thereby improving the combustion characteristics.

In the intake system according to the aspect of the invention described above, the intake air control valve may include an other end portion that is on the opposite side of the one end portion, and the gap minimizing portion may be formed at a position that is closer to the one end portion than to the other end portion.

With the configuration as described above, it is possible to minimize the gap between the one end portion of the intake air control valve and the wall surface of the intake passage while suppressing an increase in the size of the gap minimizing portion, because the gap minimizing portion is provided near the one end portion of the intake air control valve.

In the intake system according to the aspect of the invention described above, the gap minimizing portion may minimize the gap between the one end portion of the intake air control valve and the wall surface of the intake passage independently of the position of the intake air control valve in the entire movable range of the intake air control valve.

With the configuration as described above, the intake air is allowed to flow in a more appropriate fashion regardless of whether the intake air control valve creates the smallest possible flow passage area or the largest possible flow passage area.

In the intake system according to the aspect of the invention described above, the intake air control valve may generate a tumble flow in the combustion chamber.

According to the aspect of invention described above, the intake air is allowed to flow in a more appropriate fashion, whereby the characteristics of combustion that takes place in the internal combustion engine are improved.

### BRIEF DESCRIPTION OF THE DRAWINGS

The foregoing and further features and advantages of the invention will become apparent from the following description of an example embodiment with reference to the accompanying drawings, wherein like numerals are used to represent like elements, and wherein:

FIG. 1 is a view showing the overall construction of an intake system for an internal combustion engine according to an embodiment of the invention;

FIG. 2 is a view showing an intake manifold and an intake air control valve included in the intake system for an internal combustion engine shown in FIG. 1; and

FIG. 3 is an enlarged view showing a portion near the intake air control valve in the intake system for an internal combustion engine shown in FIG. 1.

### DETAILED DESCRIPTION OF THE EMBODIMENT

Hereafter, an embodiment of the invention will be described. The same or corresponding portions will be denoted by the same reference numerals, and the description thereof will be provided only once below.

It should be noted that the descriptions concerning the number of pieces, quantity, and the like in the embodiment do not limit the scope of the invention unless otherwise specified. Further, the constituent elements described in the embodiment are not absolutely essential for the invention unless otherwise specified. Still further, in a case where there are various embodiments of the invention, the configurations in the embodiments may be appropriately combined with each other unless otherwise specified. Combining the configurations with each other is within the scope of the assumption.

An “internal combustion engine” described in the specification may be a gasoline engine or may be a diesel engine. An injector provided in the internal combustion engine may be an injector that injects fuel into an intake passage, or an injector that injects fuel into a cylinder. Further, both types of injectors described above may be provided in the internal combustion engine.

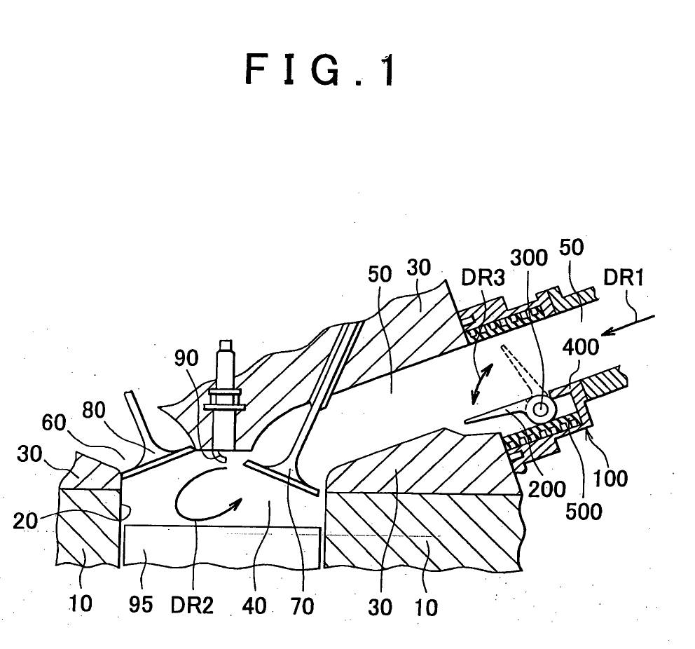

FIG. 1 is a view showing the overall construction of an intake system for an internal combustion engine according to an embodiment of the invention. Referring to FIG. 1, a cylinder 20 is formed in a cylinder block 10, and a pent-roofed combustion chamber 40 is formed in a cylinder head 30 that covers the cylinder 20 from above. An intake passage 50 and an exhaust passage 60 are formed in a manner such that the passages are connected to respective two inclined planes that form the combustion chamber 40. The intake valve 70 opens and closes an opening at the end of the intake passage 50, and the exhaust valve 80 opens and closes an opening at the end of the exhaust passage 60. An end portion of the intake passage 50 is divided into two separate branches. Each cylinder 20 is provided with two intake valves 70 that open and close openings at the ends of the respective branches. Each cylinder 20 is also provided with two exhaust valves 80. A plug 90 is disposed in a top center portion of the combustion chamber 40 which is surrounded by these four valves. A piston 95 is provided in the cylinder 20. In an example shown in FIG. 1, the piston 95 has a flat top surface. However, the top surface of the piston 95 may be formed in a desired shape that is suitable for, for example, stratified charge combustion.

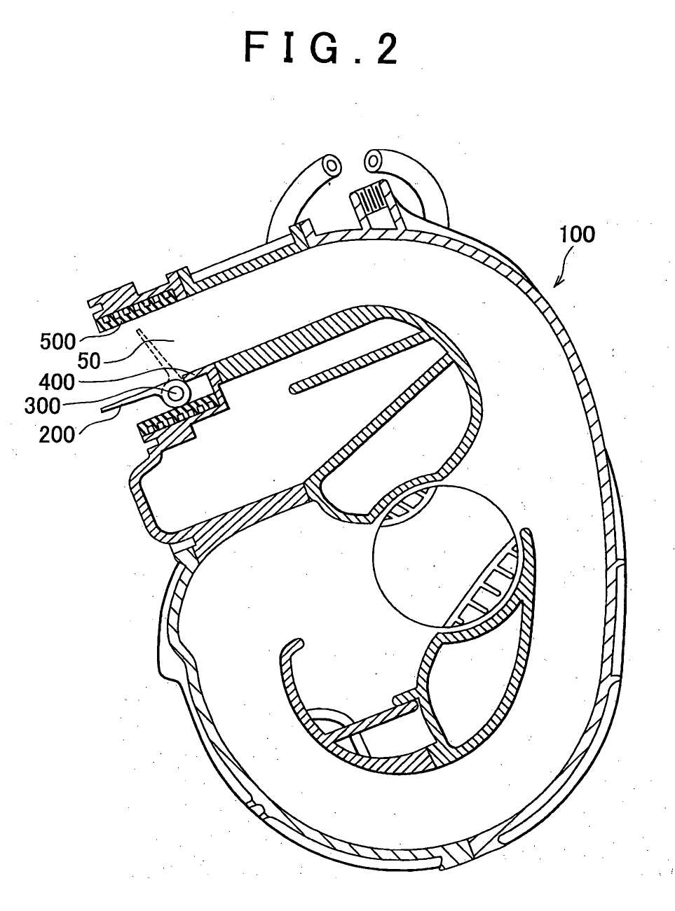

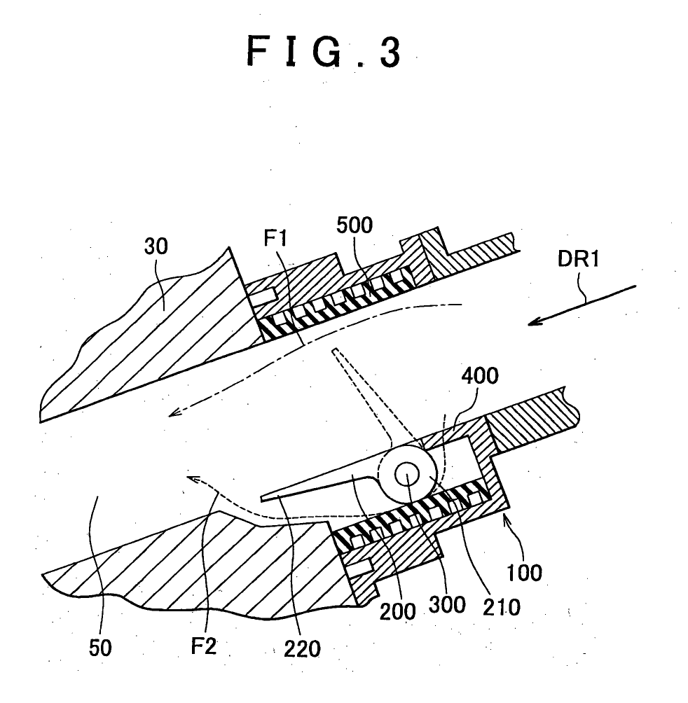

The intake system for an internal combustion engine according to the embodiment of the invention will be described with reference to FIGS. 2 and 3 in addition to FIG. 1. FIG. 2 is a view showing an intake manifold 100 and an intake air control valve 200 included in the intake system according to the embodiment of the invention. FIG. 3 is an enlarged view showing a portion of the intake system, which is near the intake air control valve 200.

As shown in FIGS. 1 to 3, the intake manifold 100 is connected to the cylinder head 30, and a cartridge 500, which serves as an “insertion member”, is inserted and fitted into the intake manifold 100. Intake air flows along the direction indicated by an arrow DR1 in FIGS. 1 and 3 through the intake passage 50 formed in the intake manifold 100, the cartridge 500, and the cylinder head 30. The intake air control valve 200 adjusts the flow passage area of the intake passage 50 so that a tumble flow, which proceeds along the direction indicated by an arrow DR2 in FIG. 1, is produced in the cylinder 20. The intake air control valve 200 and a valve shaft 300 are fitted to the cartridge 500. The valve shaft 300 supports one end portion (a base portion) 210 of the intake air control valve 200 in a manner such that the intake air control valve 200 is allowed to pivot about the valve shaft 300. This allows the intake air control valve 200 to pivot in the direction indicated by an arrow DR3 in FIG. 1, whereby the flow passage area of the intake passage 50 is adjusted by operating the intake air control valve 200.

Dashed lines shown in FIGS. 1 to 3 indicate the position of the intake air control valve 200 when the flow passage area of the intake passage 50 is minimized by the intake air control valve 200. When the flow passage area of the intake passage 50 is minimized by the intake air control valve 200, a main flow of the air (indicated by an arrow F1 in FIG. 3) that passes through a clearance left between the other end portion (a leading end portion) 220 of the intake air control valve 200 and a wall surface of the intake passage 50 produces a vortex flow (a tumble flow) in the combustion chamber 40. This promotes, for example, mixing of air and fuel and propagation of spark-ignited flame in the combustion chamber 40, whereby the combustion efficiency is enhanced.

When the intake air control valve 200 is operated to produce a vortex flow (a tumble flow), if a strong air flow (indicated by an arrow F2 in FIG. 3) passes through a gap formed between the one end portion 210 of the intake air control valve 200 and the wall surface of the intake passage 50, the strong air flow disturbs the main flow indicated by the arrow F1, resulting in hindrance to homogenization of the intake air (i.e. homogenization of the air-fuel mixture). This also results in hindrance to improvement of the characteristics of combustion that takes place in the internal combustion engine.

The intake system for an internal combustion engine according to the embodiment of the invention includes a guide rib 400. The guide rib 400 protrudes from the intake manifold 100 toward the one end portion 210 of the intake air control valve 20 so that the gap between the one end portion 210 and the wall surface of the intake passage 50 is minimized. Because the guide rib 400 minimizes the gap between the one end portion 210 of the intake air control valve 200 and the wall surface of the intake passage 50, the air flow that passes through the gap as indicated by the arrow F2 is suppressed. Accordingly, the characteristics of combustion that takes place in the internal combustion engine are improved.

The guide rib 400 extends along the direction in which the intake passage 50 extends (that is, along the direction indicated by the arrow DR1), and forms a part of the intake passage 50. This configuration minimizes the influence of the presence of the guide rib 400 on the flow of the intake air.

Further, the guide rib 400 is formed at a position that is closer to the one end portion 210 of the intake air control valve 200 than to the other end portion 220 of the intake air control valve 200. This configuration minimizes the gap between the one end portion 210 of the intake air control valve 200 and the wall surface of the intake passage 50, while suppressing an increase in the size of the guide rib 400.

The guide rib 400 minimizes the above-mentioned gap regardless of whether the intake air control valve 200 creates the smallest possible flow passage area or the largest possible flow passage area. In other words, the guide rib 400 minimizes the gap between the one end portion 210 of the intake air control valve 200 and the wall surface of the intake passage 50 independently of the position of the intake air control valve 200 in its entire movable range. Further, the guide rib 400 is configured in such a manner that the guide rib 400 does not interfere with the pivot motion of the intake air control valve 200.

The guide rib 400 is formed so as to be even with the wall surface of the intake passage 50 formed in the intake manifold 100. Further, the guide rib 400 is formed integrally with a component that constitutes the intake manifold 100. In this way, the guide rib 400 is produced at a lower cost.

The description below is a summary of the detailed description of the embodiment of the invention. That is, the intake system for an internal combustion engine according to the embodiment of the invention includes: the intake passage 50 through which the intake air is introduced into the combustion chamber 40 of the internal combustion engine; the intake manifold 100 that is attached to the cylinder head 30 and that forms a part of the intake passage 50; the intake air control valve 200 that reduces the flow passage area of at least a part of the intake passage 50; the valve shaft 300 that supports the one end portion 210 of the intake air control valve 200 in a manner such that the intake air control valve 200 is allowed to pivot about the valve shaft 300; a guide rib 400 that protrudes from the intake manifold 100, which is a component other than the intake air control valve 200, toward the one end portion 210 of the intake air control valve 200, and that functions as a “gap minimizing portion” which minimizes the gap between the one end portion 210 and a portion of the wall surface of the intake passage 50, which is close to the valve shaft 300.

In the embodiment of the invention, the guide rib 400 is formed integrally with the intake manifold 100. Alternatively, the guide rib 400 that functions as the “gap minimizing portion” may be formed integrally with the cartridge 500.

Thus, the embodiment of the invention that has been disclosed in the specification is to be considered in all respects as illustrative and not restrictive. The technical scope of the invention is defined by claims, and all changes which come within the meaning and range of equivalency of the claims are therefore intended to be embraced therein.

1. An intake system for an internal combustion engine, which introduces intake air into a combustion chamber of the internal combustion engine, comprising:
an intake passage through which the intake air flows;
an intake manifold that is attached to the internal combustion engine and that forms a part of the intake passage;
an intake air control valve that is able to reduce a flow passage area of at least a part of the intake passage, said intake air control valve comprising a first face adjacent to the intake passage and a second opposing face;
a valve shaft that supports a first end portion of the intake air control valve in a manner such that the intake air control valve is allowed to pivot about the valve shaft; and
a gap minimizing portion extending along and in alignment with a wall surface portion of the intake passage immediately upstream of the intake air control valve, wherein
a distal end of said gap minimizing portion terminates immediately adjacent to said first end portion of the intake air control valve and is adapted to permit the intake air control valve to travel through its entire movable range and at each position of said intake air control valve throughout said range to prevent air from flowing outside of a boundary defined by the intake passage and around the second opposing face of the intake air control valve.

2. The intake system according to claim 1, wherein the component other than the intake air control valve is included in the intake manifold.

3. The intake system according to claim 1, further comprising:
an insertion member that is inserted and fitted into the intake manifold and that forms a part of the intake passage,
wherein the component other than the intake air control valve is the insertion member.

4. The intake system according to claim 1, wherein the gap minimizing portion extends along a direction in which the intake passage extends, and forms a part of the intake passage.

5. The intake system according to claim 1,
wherein:
the intake air control valve includes an other end portion that is on an opposite side of the one end portion; and
the gap minimizing portion is formed at a position that is closer to the one end portion than to the other end portion.

6. The intake system according to claim 1, wherein the gap minimizing portion minimizes the gap between the one end portion of the intake air control valve and the wall surface of the intake passage independently of a position of the intake air control valve in an entire movable range of the intake air control valve.

7. The intake system according to claim 1,
wherein the intake air control valve generates a tumble flow in the combustion chamber.
